(19) United States
(12) Patent Application Publication
(10) Pub. No.: US 2026/0300732 A1
(43) Pub. Date: Oct. 1, 2026

(54) ADAPTIVE ATTENTION HEAD PRUNING FOR EFFICIENT TRANSFORMER MODEL INFERENCE

(71) Applicant: Intuit Inc., Mountain View, CA (US)

(72) Inventors: Linoy COHEN, Petah Tikva (IL); Matan VETZLER, Petah Tikva (IL); Shai ARDAZI, Petah Tikva (IL); Tom KLEIN, Petah Tikva (IL)

(73) Assignee: Intuit Inc., Mountain View, CA (US)

(21) Appl. No.: 19/090,238

(22) Filed: Mar. 25, 2025

(51) Int. Cl. G06N 3/082; G06N 3/0455

(52) U.S. Cl. CPC G06N 3/082; G06N 3/0455

(57) ABSTRACT

A method includes receiving a prompt from a user application. The method further includes processing the prompt with a configuration classifier to obtain an attention head ranking. The attention head ranking includes a ranked list of attention head identifiers and corresponding attention head weights of a transformer model. The method further includes configuring the transformer model according to the attention head ranking by activating active attention heads and deactivating inactive attention heads of the transformer model, to obtain a configured transformer model. The method further includes processing the prompt by the configured transformer model to obtain a response.

### BACKGROUND

Transformer-based artificial intelligence (AI) models are large-scale machine learning models, such as large language models (LLMs), foundation models, generative AI models, and AI agents. Transformer-based AI models have a transformer model architecture, which includes attention layers in encoder and decoder components. Transformer-based AI models may be integrated into product offerings and internal software development platforms. The products and platforms may be referred to as AI native products and platforms. For example, many online e-commerce platforms are AI-native, and have AI-powered features. AI-powered features include chatbots, virtual assistants, product recommendations, personalized sales communications, dynamic pricing, visual and voice search, etc. Technology businesses such as retail software products, telecommunications, and social media may internally deploy AI-native development and operations platforms. These platforms may be used by software engineers, marketing and sales teams, and customer support personnel. Further, legacy data and operations platforms in financial, healthcare, government, defense, and media domains are rapidly adapting to transformer-based AI models as core computational engines.

The large-scale usage of transformer-based AI models in software products and platforms amounts to millions of programmatic or direct calls to the models per second. This usage translates into large computational costs. A challenge arises in managing the computational burden and resulting delays experienced by users interacting with transformer-based AI models, particularly LLMs and foundation models.

### SUMMARY

In general, in one aspect, one or more embodiments relate to a method. The method includes receiving a prompt from a user application. The method further includes processing the prompt with a configuration classifier to obtain an attention head ranking. The attention head ranking includes a ranked list of attention head identifiers and corresponding attention head weights of a transformer model. The method further includes configuring the transformer model according to the attention head ranking by activating active attention heads and deactivating inactive attention heads of the transformer model, to obtain a configured transformer model. The method further includes processing the prompt by the configured transformer model to obtain a response.

In general, in one aspect, one or more embodiments relate to a system. The system includes at least one computer processor. The system further includes a configuration classifier, executing on the at least one computer processor, a transformer model, executing on the at least one computer processor, and an attention head configurator, executing on the at least one computer processor. The system is configured for receiving a prompt from a user application, and processing the prompt with a configuration classifier to obtain an attention head ranking. The attention head ranking includes a ranked list of attention head identifiers and corresponding attention head weights, of the transformer model. The system is further configured for configuring the transformer model by the attention head configurator according to the attention head ranking by activating active attention heads and deactivating inactive attention heads of the transformer model, to obtain a configured transformer model. The system is further configured for processing the prompt by the configured transformer model to obtain a response.

In general, in one aspect, one or more embodiments relate to a method. The method includes generating a training dataset for a configuration classifier by selecting a plurality of training prompts and corresponding training response relevancy thresholds from training data. Generating the training dataset further includes processing a training prompt of the plurality of training prompts by a transformer model to obtain a corresponding training response. Generating the training dataset further includes obtaining attention head identifiers and corresponding attention head weights of attention heads used by the transformer model to generate the corresponding training response. Generating the training dataset further includes generating an attention head ranking corresponding to the training prompt, comprising a ranked list having the attention head identifiers and the corresponding attention head weights. The position of an attention head identifier in the ranked list is based on a corresponding attention head weight. Generating the training dataset further includes adding the training prompt paired with the attention head ranking to the training dataset. The method further includes training the configuration classifier to take as input a user prompt, and generate an output attention head ranking corresponding to the user prompt. The method further includes configuring the transformer model according to the output attention head ranking by activating active attention heads and deactivating inactive attention heads of the transformer model to obtain a configured transformer model. The method further includes processing the user prompt by the configured transformer model to obtain a response.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method, in accordance with one or more embodiments.

FIG. 3 shows a flowchart of a method, in accordance with one or more embodiments.

FIG. 4 shows a flowchart of a method, in accordance with one or more embodiments.

FIG. 5 shows an example of a prompt processed by a transformer model with pruned attention heads, in accordance with one or more embodiments.

FIGS. 6A and 6B show a computing system, in accordance with one or more embodiments.

Like elements in the various figures are denoted by like reference numerals for consistency.

### DETAILED DESCRIPTION

One or more embodiments are directed to managing computing resource usage of transformer-based AI models (i.e., “transformer models”). A large portion of this computational burden comes from attention heads, or the attention mechanism of the attention layers of the transformer model. The parallel execution and simultaneous information processing of the multiple attention heads of the attention layers results in slower response times. Further, the multiple attention heads increase energy consumption, leading to further technical challenges in deploying large-scale transformer models efficiently in real-time applications. Further, if attention heads are removed before inference time, then the quality and accuracy of the model output may result.

One or more embodiments are directed to improving the efficiency of transformer models during an inference cycle by dynamically configuring the attention layers of the models based on the input received during inference. In one or more embodiments, the input to be processed by the transformer model may be analyzed by a configuration classifier. The output of the configuration classifier may identify certain attention heads, or individual attention mechanisms, of the transformer model that might be less essential for generating an appropriate response to the input. The identified attention heads are “pruned” from the attention layer by deactivating the pruned attention heads during the particular inference cycle. The deactivated attention heads may be reactivated for subsequent inference cycles based on different received input.

The configuration classifier may be trained to output an attention head ranking based on an input prompt using a training dataset. Generating the training dataset may entail processing a set of training prompts with the transformer model to obtain corresponding responses. Additionally, a list of attention heads and corresponding attention head weights used to generate the corresponding responses may be obtained. The list of attention heads may be ranked based on the corresponding attention head weights. Further, the system determines a stop position using the ranking such that attention heads below the stop position are pruned. Thus, the computational burden of the transformer model is reduced, while preserving the accuracy of the response, by dynamically selecting the attention heads in real time that have the most relevance to the input prompt.

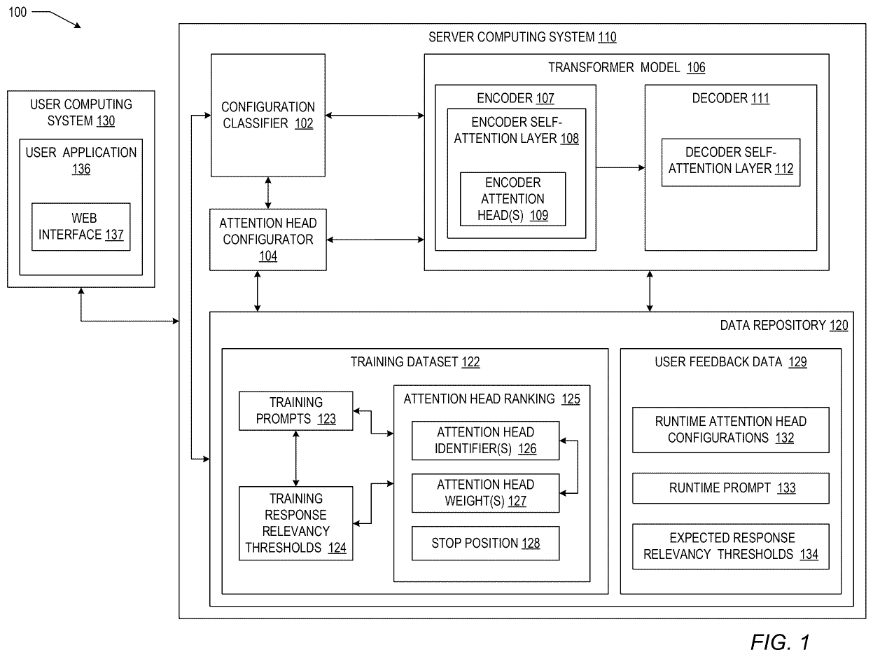

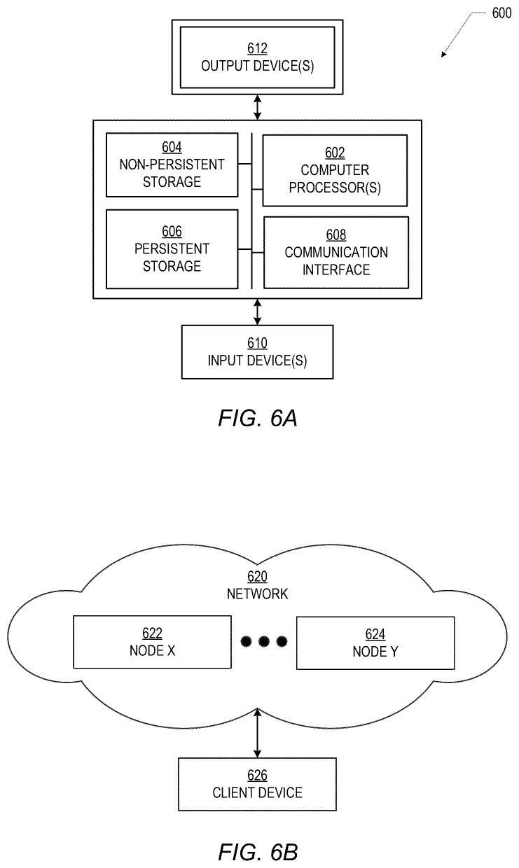

Attention is now turned to the figures. FIG. 1 shows a computing system (100), in accordance with one or more embodiments. The computing system (100) includes a user computing system (130) and a server computing system (110). The server computing system (110) is one or more computer processors, data repositories, communication devices, and supporting hardware and software. The server computing system (110) may be in a distributed computing environment. The server computing system (110) is configured to execute one or more applications, such as the configuration classifier (102), the transformer model (106), and the attention head configurator (104). The server computing system (110) includes a computer processor. The computer processor is one or more hardware or virtual processors which may execute computer readable program code that defines one or more applications, such as the configuration classifier (102), the transformer model (106), and the attention head configurator (104). An example of the computer processor is described with respect to the computer processor(s) (602) of FIG. 6A.

The server computing system (110) of the system (100) shown in FIG. 1 includes a data repository (120). The data repository (120) is a type of storage unit or device (e.g., a file system, database, data structure, or any other storage mechanism) for storing data. The data repository (120) may include multiple different, potentially heterogeneous, storage units and/or physical storage devices.

The data repository (120) includes a training dataset (122). The training dataset (122) is used to train the configuration classifier (102). The training dataset (122) includes one or more training prompts (123). A prompt is a natural language utterance. Prompts may be directly provided by a user of a user application via a web interface. Additionally, prompts may be programmatically provided via application programming interface (API) calls to large artificial intelligence or machine learning models, such as a large language model (LLM). An LLM is a type of a transformer model. A prompt may be provided to other types of transformer models, such as foundation models custom trained as generative artificial intelligence (AI) models for a particular application domain.

The natural language utterances of a prompt may include one or more inputs, one or more instructions, and/or one or more examples. Inputs of a prompt refer to information or data provided to the transformer model to process and generate a response. Inputs may include text, numbers, or other forms of data that the transformer model uses to understand the context and produce relevant outputs. Instructions of a prompt refer to directives or guidelines given to the transformer model to shape the response. Instructions may inform the transformer model how to handle the input, what kind of response is expected, and any specific rules or constraints to be followed. For example, instructions might specify the tone, length, or format of the response, particular sources of information to use as references, etc. Examples of a prompt refer to sample inputs and corresponding outputs provided to the transformer model to illustrate the desired behavior. The examples may facilitate the transformer model to comprehend appropriate responses. Examples may further serve as a reference for generating similar outputs in new situations. Thus, the training prompts (123) may include inputs, instructions, and examples.

The training dataset (122) further includes one or more training response relevancy thresholds (124). A training response relevancy threshold refers to a minimum relevancy score that is expected of a given response generated by the transformer model (106) processing a given training prompt. Thus, there exists a one-to-one mapping between training prompts (123) and training response relevancy thresholds (124) of the training dataset (122). For example, for a given training prompt “What does cardinality of a set mean?,” a training response relevancy threshold may be 98%. On the other hand, for another training prompt “Is blue considered a cool paint color for a room?,” the training response relevancy threshold may be 65%.

The training dataset includes one or more attention head rankings (125). In one or more embodiments, an attention head ranking may include information related to attention heads of the transformer model (106) used by the transformer model (106) to generate a response for a training prompt. Thus, a one-to-one mapping exists between a given training prompt and a given attention head ranking. More particularly, the attention head ranking (125) may include a ranked list. The ranked list may include attention head identifiers (126) and corresponding attention head weights (127). The attention head identifiers (126) may identify attention heads of a transformer model. In one or more embodiments, the attention head identifiers (126) may identify encoder attention heads (109) in an encoder self-attention layer (108) of an encoder (107) in the transformer model (106). Within the training dataset, a one-to-one mapping exists between a given training prompt, a given training response relevancy threshold and a given attention head ranking.

An element of the ranked list of the attention head ranking includes an attention head identifier (126), and a corresponding attention head weight (127). The attention head weight (127) corresponding to an attention head identifier (126) serves as a relevancy score of the corresponding attention head with respect to the corresponding training prompt. In other words, the attention head weight of an attention head with respect to a particular training prompt, is indicative of the importance of that attention head with respect to the particular training prompt. An attention head weight (127) may be obtained when an attention head performs a self-attention operation on tokens of the training prompt. Thus, the value of the attention head weight (127) is dependent on the training prompt being processed by the attention head. The attention head, in turn, is identified by the attention head identifier (126). In one example, the attention head weight of an attention head for a given training prompt may be determined by calculating the average attention weights across all tokens of the training prompt computed by the attention head. For instance, let a tokenized training prompt be {“the,” “cat,” “in,” “the,” “hat”}. Further, let the attention weights computed by an attention head A1 for each token of the training prompt be {W1, W2, W3, W4, W5}. Then the attention head weight corresponding to the attention head A1, for the training prompt “the cat in the hat,” may be the average of token attention weights {W1, W2, W3, W4, W5}.

Individual attention head identifiers (126) and corresponding attention head weights (127) of an attention head ranking (125) may constitute the elements of the ranked list. The elements may be arranged within the ranked list in an order based on the attention head weights (127). That is, the position of an element of the ranked list is based on the attention head weight (127) of the element. For example, the attention head identifiers (126) may be arranged in order of decreasing attention head weights (127). Other arrangements may be possible.

The attention head ranking (125) further includes a stop position (128). The stop position (128) identifies the position in the ranked list of the attention head ranking (125) where a cumulative relevance of the attention head weights (127) satisfies the corresponding training response relevancy threshold (124). The cumulative relevance of an element of the ranked list is the summation of the attention head weights up to the position of the element in the ranked list. For example, the training response relevancy threshold for a given training prompt may be 85%. The attention head ranking corresponding to the training prompt may include a ranked list having attention head identifiers and attention head weights: {A1, 0.43; A2, 0.34; A3, 0.05; A4, 0.03; A5, 0.02}. The cumulative relevance of the attention head weights for each position of the ranked list may be {position 1=0.43; position 2=0.77 (i.e., 0.43+0.34); position 3=0.82 (i.e., 0.43+0.34+0.05); position 4=0.85; position 5=0.87}. Notably, at position 4, the cumulative relevance meets the expected response relevance threshold, namely, 85% or 0.85. Thus, the stop position for the attention head ranking may be assigned a value of 4.

The training dataset (122) may be stored in the data repository (120) in various data structures, such as dictionaries of lists, Pandas DataFrames, named tuples, custom classes, etc. Thus, when the training dataset (122) is used to train the configuration classifier (102), the configuration classifier (102) learns to output an attention head ranking corresponding to a given training prompt.

The data repository (120) further includes a user feedback data (129) log. The user feedback data (129) log may include information obtained from one or more user applications (136) using the transformer model (106). The information may be used to retrain the configuration classifier (102) to improve the performance of the configuration classifier (102). More specifically, the user feedback data (129) log may include runtime prompts (133) obtained from the user applications (136). The runtime prompts (133) may be transmitted to the transformer model (106) by a user directly through a web interface (137) of the user application (136), or programmatically via business logic of the user application (136). The runtime prompts (133) may be associated with runtime attention head configurations (132). A runtime attention head configuration (132) may include a list of attention head identifiers and corresponding activation status indicators of “active” and/or “inactive,” or variations thereof. Thus, a runtime attention head configuration (132) identifies which attention heads were used and/or unused in response generation for the particular runtime prompt by the transformer model (106).

Continuing with the same example, attention heads identified by attention head identifiers {A1, A2, A3, A4} may be used by the transformer model to generate a response for a runtime prompt. However, an actual response relevancy score of the generated response may be merely 80%. In other words, the actual response relevancy score is less than the expected response relevancy threshold (85%) of the example. Since the actual response relevancy score falls below the expected response relevancy threshold, the particular runtime prompt (133) and runtime attention head configuration (132) may be stored in the user feedback data (129) log. Additionally, the expected response relevancy threshold (134) may be stored in the user feedback data (129) log.

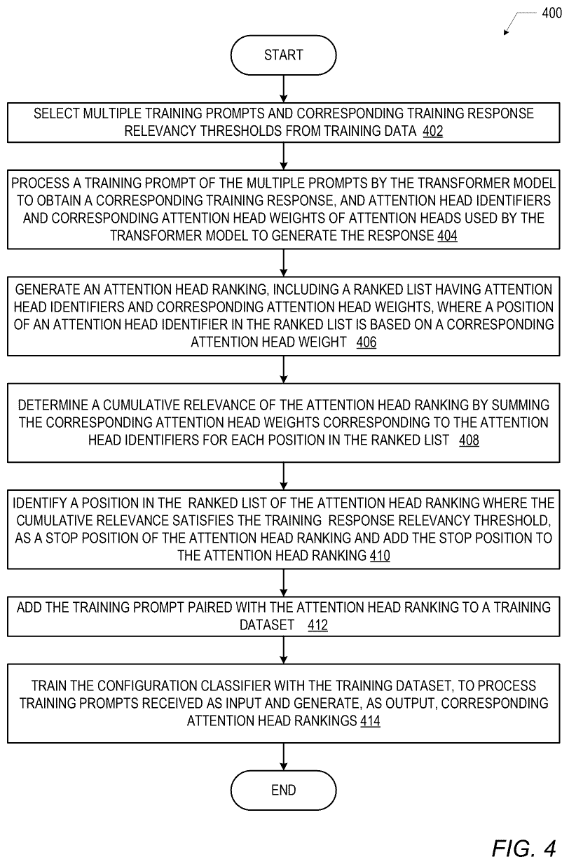

The server computing system (110) further includes a configuration classifier (102). The configuration classifier (102) is a classifier machine learning (ML) model. Classifier ML models are trained by using supervised learning techniques. Supervised learning is a type of machine learning in which a ML model is trained on labeled training data. A label is the output or target information that the ML model is trying to predict. Each piece of labeled training data consists of an input and the corresponding label. The goal of supervised learning is for a machine learning model to learn a mapping from inputs to outputs. Thus, the machine learning model may predict the output for new, unseen inputs when deployed to a production system. Examples of classifier ML models include linear models, decision trees, and support vector machines. Additional examples include neural networks such as feedforward neural networks, convolutional neural networks (CNN), recurrent neural networks, gradient boosting machines, random forest ensembles of decision trees, etc. Training of the configuration classifier (102) is described in detail in reference to FIG. 4.

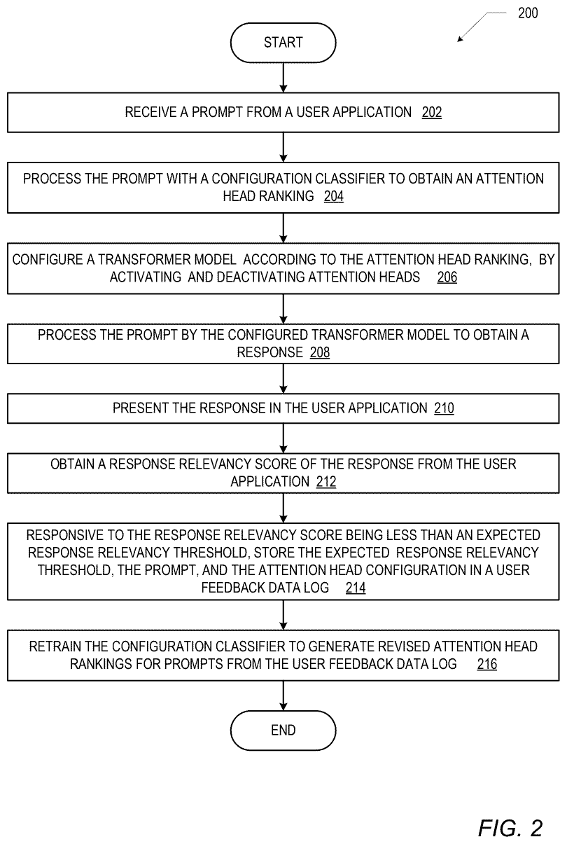

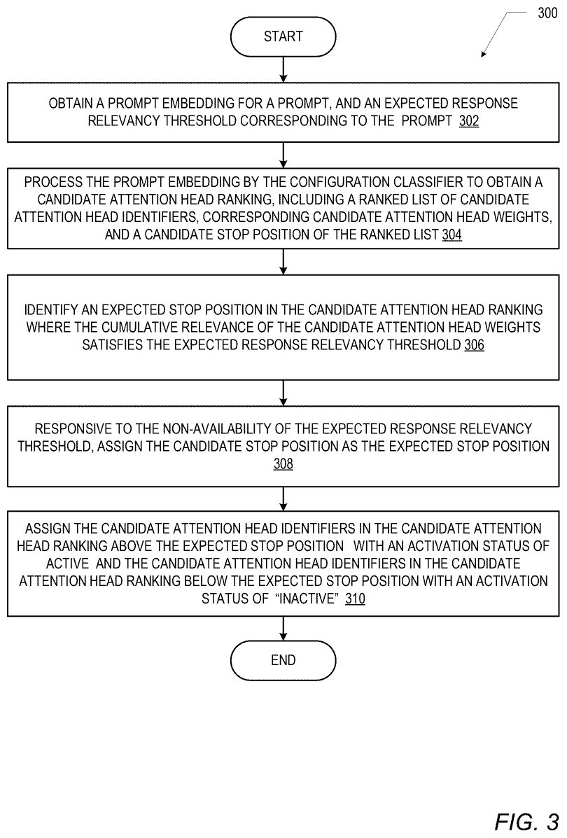

The server computing system (110) further includes an attention head configurator (104). The attention head configurator (104) is software or application-specific hardware, which, when executing on a computer processor, essentially performs the methods of FIG. 2, and FIG. 3. The attention head configurator (104) further coordinates the execution of the configuration classifier (102), and transformer model (106). In one or more embodiments, the attention head configurator (104) may receive user feedback data (129) from the user application (136) related to responses generated by the transformer model (106) for a given user prompt and store the user feedback data (129) in the data repository (120). Further, the attention head configurator (104) may coordinate the generation of the training dataset (122) in conjunction with the transformer model (106). Additionally, the attention head configurator (104) may coordinate the training and retraining of the configuration classifier (102).

The server computing system (110) further includes a transformer model (106). A transformer model is a type of deep learning model used in natural language processing, image processing, and other deep learning tasks. A transformer model architecture may include diverse configurations of encoders and decoders. Encoders of a transformer model may process input sequences and generate contextual representations of the input sequences. Decoders may use the output of encoders to generate a final output sequence. Transformer model architecture may be a base architecture for foundation models. Foundation models are large-scale AI models trained on a vast amount of diverse data, designed to be adaptable to a wide range of tasks. Foundation models serve as a base upon which more specific models can be fine-tuned for particular applications. In other words, the original model provides a base (hence “foundation”) on which application, or domain-specific models can be built. The transformer model (106) may be a type of foundation model specifically focused on natural language processing tasks. The transformer model (106) may be trained on extensive text data to understand and generate human-like text. Examples of foundation models trained in such a manner include GPT-3 and BERT. The transformer model (106) may be further trained on particular knowledge domains, for example, financial knowledge domains. An example of a foundation model further trained in financial knowledge domains for financial technology applications is the LLM used in Intuit's Generative AI operating system. The components of the transformer model (106) as shown in FIG. 1 are comparable to components of transformer model architectures.

The transformer model (106) further includes at least one encoder (107). The encoder (107) of the transformer model (106) is a component which processes an input sequence, such as a training prompt or user prompt, to generate a rich, contextual representation of the prompt. The encoder is responsible for capturing the relationships and dependencies between tokens in the input sequence, regardless of their distance from each other. As a general overview, an encoder of a transformer model may include an embedding layer (not shown in FIG. 1), which converts input tokens such as words, sub-words, sentences, numbers etc. to dense vectors of a fixed size, called embeddings. That is, the encoder converts input tokens to input embeddings. The encoder may further include a positional encoding module (not shown in FIG. 1), that adds positional information to the input embeddings. Positional encodings are generated using sine and cosine functions of different frequencies and added to the input embeddings as positional information.

The encoder (107) may further include an encoder self-attention layer (108). The encoder self-attention layer (108) includes multiple encoder attention head(s) (109). Encoder attention head(s) (109) may be identified in attention head rankings (125) by attention head identifiers (126). An attention head is an instance of a self-attention mechanism. Further, the multiple encoder attention heads may be configured to capture diverse relationships between tokens of an input sequence. For example, a first attention head of the multiple encoder attention heads may focus on question words in a given input sequence. A second attention head may focus on the sentence subject in the input sequence. A third attention head may focus on key phrases in the input sequence. Other attention heads may respectively focus on the verbs, contextual relationships, negation, and polarity, etc. of the input sequence. Thus, each individual attention head may assign different attention weights to the tokens of an input sequence based on the perspective of the individual attention head. For example, for a prompt “Do you think that climate change is real,” attention head 1 may assign weights {Do: 0.4, you: 0.3, think: 0.2, that: 0.05, climate: 0.02, change: 0.02, is: 0.01, real: 0.01}. On the other hand, attention head 3 may assign weights {Do: 0.05, you: 0.05, think: 0.1, that: 0.1, climate: 0.3, change: 0.3, is: 0.05, real: 0.05}.

A detailed description of a self-attention mechanism is set forth herein. A self-attention mechanism in a transformer model can be understood as a combination of several software components and functions. Typically, in transformer model architecture, a self-attention mechanism may include linear and softmax neural network layers. The self-attention mechanism may further include computer program code for dot product calculation, scaling, softmax, and weighted sum functions. The self-attention mechanism may further include data structures such as matrices or tensors. In one or more implementations, self-attention mechanisms may be implemented as modules, or classes, which encapsulate these components and functions. Examples of self-attention mechanism implementations may be found in deep-learning platforms such as TensorFlow or Pytorch. Self-attention mechanisms may be included in encoders, decoders, and other components of transformer models.

A self-attention operation performed by a self-attention mechanism weighs the importance of different embeddings (of tokens) in an input sequence (a prompt). An embedding X may correspond to a token in the input sequence. Three vectors may be computed for the embedding X: Query (Q), Key (K), and Value (V). The vectors Q, K, and V may be obtained by multiplying the embedding with learned weight matrices, W_{Q}, W_{K}, and W_{V} respectively, in accordance with Equation group (1):

$$Q = {XW}_{Q} ; K = {XW}_{K} ; V = {XW}_{V} \qquad ( 1 )$$

The learned weight matrices may be learned by the attention head during training of the transformer model.

Further, the embedding of each token may be paired with the embeddings of every other token in the input token sequence. The attention score for each token pair may be calculated by taking the dot product of the query vector of a given token with the key vector of each of the tokens. The dot product measures the relevance of one token to another. The dot product scores may be scaled by the square root of the dimension of the key vectors to stabilize gradients, for example, in accordance with Equation (2):

$$Attention score = \frac{Q \cdot {K}^{T}}{{\sqrt{d}}_{k}} \qquad ( 2 )$$

In Equation (2), dₖ is the dimension of the key vectors (K).

The attention scores may further be passed through a softmax function to obtain the attention weights for each token. The attention weights of each token may be used to compute a weighted sum of the value vectors (V), to produce a final output for each token. The final output may be a context-aware representation of each token of the input sequence.

In the encoder (107), multiple encoder attention heads (109) form the encoder self-attention layer (108). Each encoder attention head (109) may perform its self-attention operation independently on a given input sequence. The multiple encoder attention heads (109) may execute in parallel. The encoder of the transformer model thus captures diverse aspects of the relationships between tokens of the given input sequence. The outputs of all the attention heads of the encoder self-attention layer (108) may be concatenated together and passed through a final linear transformation to combine the information from the multiple encoder attention heads (109).

Additional layers of the encoder (107) may include a feedforward neural network (not shown in FIG. 1) through which the output of the encoder self-attention layer (108) is passed. Further, each layer of the encoder may be normalized and combined with its respective input through residual connections.

The transformer model (106) further includes at least one decoder (111). The decoder (111) generates an output sequence based on the input sequence. The decoder (111) may include an embedding layer (not shown in FIG. 1) that converts target sequence tokens into embeddings. The decoder (111) may further include a positional encoding module that adds positional information to the target sequence embeddings. The decoder (111) further includes a decoder self-attention layer (112), structured in a similar manner to the encoder self-attention layer (108). Additionally, the decoder (111) may include a masked multi-head self-attention layer (not shown in FIG. 1) that causes the transformer model (106) to focus on different parts of the target sequence while preventing attention to future tokens. Further, the decoder (111) may include an encoder-decoder attention layer (not shown in FIG. 1), that takes output from the encoder (107) to incorporate information from the input sequence of the encoder (107). Additional layers of the decoder (111) may include a feedforward neural network (not shown in FIG. 1) through which the output of the decoder self-attention layer is passed. Further, each layer of the decoder may be normalized and combined with its respective input through residual connections.

The system (100) shown in FIG. 1 may further include one or more user computing systems (130). The user computing systems (130) may be considered remote or local. A remote user computing system may be operated by a third-party (e.g., an end user of a chatbot) that does not control or operate the system of FIG. 1. Similarly, the organization that controls the other elements of the system of FIG. 1 may not control or operate the remote user computing system (130). Thus, a remote user computing system (130) may not be considered part of the system of FIG. 1.

In contrast, a local user computing system (130) may be operated under the control of the organization that controls the other components of the system of FIG. 1. Thus, a local user computing system (130) may be considered part of the system of FIG. 1. The user computing systems (130) may be computing systems (e.g., the computing system (600) shown in FIG. 6A) that communicate with the server computing system (110).

The user computing system (130) further includes a user application (136) having a web interface (137). A user may enter prompts addressed to the transformer model (106) via the web interface (137) of the user application (136). The user application (136) may include business logic to programmatically invoke the transformer model (106) to process the prompts. Additionally, or alternatively, prompts may be generated by the user application (136) business logic based on user behavior patterns and transmitted to the server computing system (110). Examples of user applications (136) interacting with transformer models may include chatbots such as ChatGPT®, Bing® Copilot, applications such as TurboTax, QuickBooks, etc.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart 200 of a method for dynamically configuring a transformer model to use selected attention heads in processing a prompt, in accordance with one or more embodiments. The method of FIG. 2 may be implemented using the system of FIG. 1 and one or more of the steps may be performed on or received at one or more computer processors. While the various steps in flowchart 200 are presented and described sequentially, at least some of the steps may be executed in different orders, may be combined, or omitted, and at least some of the steps may be executed in parallel. Furthermore, the steps may be performed actively or passively.

In Block 202, a prompt is received from a user application. In one or more embodiments, the prompt may be received by the attention head configurator of FIG. 1. In other embodiments.

In Block 204, the prompt is processed with a configuration classifier to obtain an attention head ranking. In one or more embodiments, the attention head ranking may be obtained from the configuration classifier processing the prompt. The attention head ranking may include attention head identifiers and corresponding attention head weights. The attention head identifiers and corresponding attention head weights may correspond to attention heads of a transformer model. The attention heads may be from the encoder self-attention layer of the transformer model. A detailed description for obtaining the attention head ranking is provided in reference to Blocks 302-308 of the method shown in FIG. 3. Thus, the steps of Block 204 may include the steps of Blocks 302-308 of FIG. 3.

In Block 206, the transformer model is configured according to the attention head ranking. The transformer model may be configured by activating and deactivating attention heads of the transformer model. In one or more embodiments, the attention head configurator may programmatically configure the transformer model to “turn off” or deactivate the encoder attention heads of the transformer model as a precursor to processing the prompt obtained in Block 204. Similarly, the attention head configurator may programmatically configure the transformer model to “turn on,” or activate the encoder attention heads of the transformer model. In this way, computational costs, and corresponding latency, and relevancy tradeoffs may be managed by this adaptive “pruning” of attention heads based on an incoming prompt.

More specifically, the transformer model may be configured according to the attention head ranking by activating active attention heads and deactivating inactive attention heads of the transformer model. Thus, a configured transformer model may be obtained. In one or more embodiments, the attention head configurator may assign the activation head identifiers of the attention head ranking with activation statuses of “active” or “inactive,” based on a stop position of the attention head ranking. Configuring the transformer model may entail selecting a first set of encoder attention heads of an encoder of the transformer model corresponding to the attention head identifiers assigned with an active activation status. The first set of encoder attention heads may then be activated. Further, a second set of encoder attention heads of the encoder of the transformer model, corresponding to the attention head identifiers assigned with an inactive attention status may be selected. The second set of encoder attention heads may be deactivated.

In Block 208, the prompt is processed by the configured transformer model to obtain a response. In one or more embodiments, the activated attention heads of the transformer model may be triggered to participate in the response generation, and the deactivated attention heads may not be triggered. In Block 210, the response obtained from Block 208 may be presented in the user application. In Block 212, a response relevancy score of the response may be obtained from the user application. In one or more embodiments, the user application may include business logic and/or functionality to obtain feedback from the user regarding responses received. The actual response relevancy score may be obtained based on user feedback. In other embodiments, the response may be analyzed by background performance and quality processes in the server computing system, and a response relevancy score may be obtained from these analytics.

In Block 214, responsive to the response relevancy score being less than an expected response relevancy threshold, the expected response relevancy threshold, the prompt, and the attention head configuration are stored in a user feedback data log. In one or more embodiments the expected response relevancy threshold may correspond to the prompt. In Block 216, the configuration classifier is retrained to generate revised attention head rankings for prompts from the user feedback data log. In one or more embodiments, the configuration classifier is retrained to generate a revised attention head ranking corresponding to the prompt. A detailed description of generating a retraining dataset for the configuration classifier is provided in reference to the method of FIG. 4.

FIG. 3 shows a flowchart 300 of a method for obtaining a candidate attention head ranking from the configuration classifier. The method further includes designating, or assigning, an activation status of “active” or “inactive” to the attention head identifiers based on a candidate stop position or an expected stop position. The method of FIG. 3 may be implemented using the system of FIG. 1 and one or more of the steps may be performed on or received at one or more computer processors. While the various steps in flowchart 300 are presented and described sequentially, at least some of the steps may be executed in different orders, may be combined, or omitted, and at least some of the steps may be executed in parallel. Furthermore, the steps may be performed actively or passively.

In Block 302, a prompt embedding is obtained for a prompt, and an expected response relevancy threshold corresponding to the prompt is obtained. In one or more embodiments, the prompt embedding may be obtained from the embedding layer of the encoder of the transformer model. The prompt embedding may further include positional encoding information obtained from the positional encoding module of the encoder. The embedding dimensions and density of the prompt embedding may be similar to training prompt embeddings generated for the training prompts during training of the configuration classifier. In one or more embodiments, the expected response relevancy threshold may be obtained from the user application via user settings or configuration information. In other embodiments, the expected response relevancy threshold may be assigned by other software or application-specific hardware of the server computer system (110) based on a determined intent of the prompt. For example, if the prompt pertains to a technical definition of a term, the expected response relevancy threshold may be a high value, such as 98%. On the other hand, if the prompt pertains to a combination of topics that do not naturally overlap, such as weather patterns and historical figures of interest, then the expected response relevancy threshold may be a low value, such as 60%.

In Block 304, the prompt embedding is processed by the configuration classifier to obtain a candidate attention head ranking. The candidate attention head ranking includes a ranked list of candidate attention head identifiers, corresponding candidate attention head weights, and a candidate stop position of the ranked list. In one or more embodiments, the configuration classifier may return the candidate attention head ranking, based on a similarity of the prompt embedding to training prompt embeddings, learned by the configuration classifier. In the situation where the expected response relevancy threshold corresponding to the prompt is available, then the candidate stop position of the attention head ranking may not be used. Instead, an expected stop position in the ranked list based on the expected response relevancy threshold may be determined. In this manner, the transformer model is dynamically configured to adapt to changing configurations and requirements of the user application to operate in reduced or enhanced capacity.

Accordingly in Block 306, an expected stop position is identified in the candidate attention head ranking where the cumulative relevance of the candidate attention head weights satisfies the expected response relevancy threshold. The candidate attention head weight satisfies the expected response relevancy threshold when the candidate attention head weight indicates that the candidate attention head produces at least as relevant a response as set by the expected response relevancy threshold. In other words, the expected stop position corresponds to a position in the ranked list of the candidate attention head ranking where the cumulative relevance is equal to or greater than the expected response relevancy threshold.

In Block 308, responsive to the non-availability of the expected response relevancy threshold, the candidate stop position is assigned as the expected stop position. In one or more embodiments, Block 308 defines a default step of the method of FIG. 3.

In Block 310, the candidate attention head identifiers above the expected stop position in the candidate attention head ranking, are assigned with an activation status of “active.” Further, the candidate attention head identifiers in the candidate attention head ranking below the expected stop position are assigned with an activation status of “inactive.” Other equivalents of activation status values may be used, for example, Boolean true/false values, numerical 0 or 1 values, etc. Further, the words “active” and “inactive” may be used with or without quotes. In one or more embodiments, the attention configurator may assign the activation status to the attention head identifiers. Thus, Block 310 may be performed in conjunction with Block 206 of the method of FIG. 2.

Notably, the attention head identifiers assigned with an active activation status may correspond to, or identify, encoder attention heads. In a similar manner, the attention head identifiers assigned with an inactive activation status may correspond to, or identify, encoder attention heads.

FIG. 4 shows a flowchart 400 of a method for generating a training dataset for training the configuration classifier, and further, training the configuration classifier with the training dataset. The method of FIG. 4 may be implemented using the system of FIG. 1 and one or more of the steps may be performed on or received at one or more computer processors. While the various steps in flowchart 400 are presented and described sequentially, at least some of the steps may be executed in different orders, may be combined, or omitted, and at least some of the steps may be executed in parallel. Furthermore, the steps may be performed actively or passively.

In Block 402, multiple training prompts and corresponding training response relevancy thresholds are selected from training data. In one or more embodiments, the training prompts and corresponding training response relevancy thresholds may be selected from previous user interaction sessions with the transformer model, user application settings and configurations, and other sources.

In Block 404, a training prompt of the multiple prompts is processed by the transformer model to obtain a corresponding training response. Further, attention head identifiers and corresponding attention head weights of attention heads used by the transformer model to generate the training response are obtained.

The transformer model may use multiple attention heads to process the training prompt to generate the training response. In one or more embodiments, the attention head weights of the multiple attention heads may be compared to determine the relative relevance of multiple attention heads with respect to the training prompt. In comparing the attention head weights, attention heads with higher attention head weights may be considered to be focusing more on relevant parts of the training prompt. Another way to determine the relative relevance of the multiple attention heads with respect to the training prompt may be to analyze a distribution of the attention weights computed by individual attention heads for tokens of the training prompt. A distribution showing higher weights concentrated on fewer tokens may indicate that a given attention head may be capturing more specific and important relationships between tokens of the training prompt. Further, based on analysis of historical prompts, responses and attention head configurations, the attention weights may be further adjusted, or undergo further transformations. Thus, the final attention head weight values may depend on the comparison methodology employed to determine the relative relevance of the multiple attention heads with respect to the training prompt. Notably, the relevance of a given attention head may vary based on the training prompt. For example, for training prompts {T1, T2, T3}, the attention heads in decreasing order of relevance may respectively be {A1, A2, A3}, {A2, A1, A3}, and {A3, A2, A1}.

Accordingly, in Block 406, an attention head ranking is generated. The attention head ranking includes a ranked list. The ranked list has attention head identifiers and corresponding attention head weights of the attention heads used by the transformer in generating the training response. Further, the position of an attention head identifier in the ranked list is based on a corresponding attention head weight. In one or more embodiments, the attention head identifier and corresponding attention head weight of the most relevant attention head with respect to the training prompt may occupy the first position in the ranked list. The second position in the ranked list may be occupied by the attention head identifier and corresponding attention head weight of the second most relevant attention head with respect to the training prompt, and so on. In one or more embodiments, a training attention head ranking corresponding to the training prompt may be generated. The training attention head ranking may include a ranked list having the attention head identifiers and the corresponding attention head weights. The position of an attention head identifier in the ranked list may be based on a corresponding attention head weight.

In Block 408, a cumulative relevance of the attention head ranking is determined. The cumulative relevance is determined by summing the attention head weights corresponding to the attention head identifiers for each position in the ranked list. For example, the ranked list may include attention head identifiers and corresponding attention head weights: {A1, 0.43; A2, 0.34; A3, 0.05; A4, 0.03; A5, 0.02}. The cumulative relevance of the attention head weights for each position of the ranked list may be:

$$\{ position 1 = 0.43 ;$$

$$position 2 = 0.77 ( i . e . , 0.43 + 0.34 ) ;$$

$$position 3 = 0.82 ( i . e . , 0.43 + 0.34 + 0.05 ) ;$$

$$position 4 = 0.85 ( i . e . , 0.43 + 0.34 + 0.05 + 0.03 ) ;$$

$$position 5 = 0.87 ( i . e . , 0.43 + 0.34 + 0.05 + 0.03 + 0.02 ) \} .$$

In one or more embodiments, the cumulative reference may be determined for the training attention head ranking.

In Block 410, a position in the ranked list of the attention head ranking, in which the cumulative relevance satisfies a training response relevancy threshold corresponding to the training prompt is identified. The cumulative relevance satisfies a training response relevancy threshold when the cumulative relevance has at least as great a relevancy as set forth by the training response relevancy threshold. The identified position in Block 410 is assigned as a stop position of the attention head ranking. The stop position is added to the attention head ranking. In one or more embodiments, the attention head ranking is the training attention head ranking. In Block 412, the training prompt paired with the attention head ranking is added to the training dataset. The training response is additionally added to the training dataset. In one or more embodiments, the training attention head ranking is the attention head ranking.

In Block 414, the configuration classifier is trained with the training dataset, to process training prompts received as input and generate as output, corresponding attention head rankings. In one or more embodiments, the configuration classifier may be trained to receive, as input, a user prompt embedding. The output generated may be an output attention head ranking, including a ranked list of attention head identifiers, and corresponding attention head weights. The output attention head ranking may further include a stop position. The stop position may correspond to a position in the ranked list where a cumulative relevance satisfies a training response relevancy threshold.

In one or more embodiments, training the configuration classifier may entail tokenizing the training prompt and generating embeddings for the tokens of the training prompt. Further, contextual representations may be generated for the embeddings of the training prompt. The configuration classifier parameters and weights may be initialized and in a forward pass, the configuration classifier may generate an attention ranking prediction, including attention head identifiers, and corresponding attention head weights. A loss function may be used to calculate the difference between the predicted attention head ranking and the actual attention head ranking, for example, mean squared error or cross-entropy loss. Further, the gradients of the loss with respect to the model parameters may be calculated. In a backpropagation pass, the model parameters may be updated using an optimization algorithm such as Adam, or stochastic gradient descent.

In one or more embodiments, the configuration classifier may be periodically retrained. In one or more embodiments, retraining may entail selecting the expected response relevancy threshold corresponding to the prompt, where the expected response relevancy threshold is greater than the response relevancy score. Further the transformer model may be configured to activate the inactive attention heads of the transformer model. The prompt may be reprocessed by the transformer model to obtain a revised response. A revised attention head ranking may be obtained. The revised attention head ranking may include a revised ranked list. The revised ranked list may include the attention head identifiers and corresponding attention head weights of the attention heads used by the transformer model to generate the revised response. Further, a revised stop position of the revised attention head ranking may be identified. The revised stop position may be a position in the revised ranked list, wherein the cumulative relevance of the attention head weights satisfies the expected response relevancy threshold. Further, the prompt paired with the revised attention head ranking, and the revised stop position may be added to a retraining dataset. The configuration classifier may be subsequently retrained with the retraining dataset to receive as input, the prompt, and to generate, as output, the revised attention head ranking.

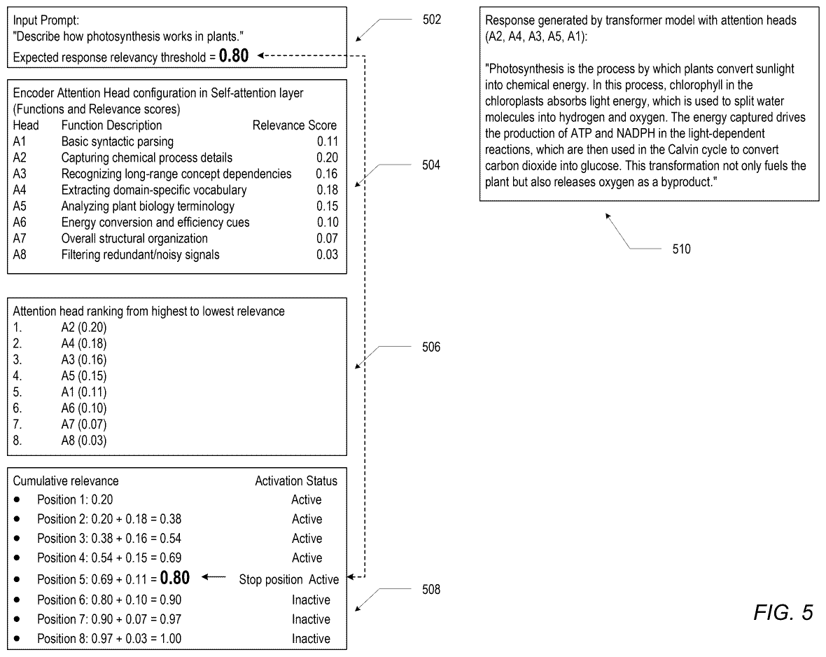

FIG. 5 shows an example of processing a prompt with pruned attention heads, in accordance with one or more embodiments. The following example is for explanatory purposes only and not intended to limit the scope of one or more embodiments.

An example of a prompt and expected response relevancy threshold obtained from a user application is shown in Block 502. The expected response relevancy threshold may be 80% (0.8). In Block 504, a sample set of attention heads of an encoder self-attention layer of the transformer model is shown. The perspective or focus of each of these attention heads (A1 through A8) may be determined by previous training analysis. As shown in Block 504, the attention head A1 may focus on the syntactic relationship of the tokens of the prompt “Describe how photosynthesis works in plants.” The attention head A4 may focus on domain-specific vocabulary of the prompt. In this instance, the attention head A4 may focus on the words “photosynthesis” and “plants,” assigning higher attention weights to the words. The attention head A8, focusing on redundant/noisy signals may return low attention weights for the tokens, as the prompt is a well-constructed and coherent sentence, with no repeated, ungrammatical, or nonsense words. Further, the attention weights assigned to the prompt by each of the attention heads is shown in Block 504.

Accordingly, in Block 506, the attention head identifiers A1 through A8, are sorted into the ranked list based on their corresponding attention head weights. As shown in Block 506, the order of the attention heads is different, as compared to Block 504. In Block 508, as the expected response relevancy threshold is available, the cumulative relevance for the attention heads in each position of the ranked list is computed. As shown in Block 508, it is at position 5 that the cumulative relevance meets the expected response relevancy threshold, as indicated by the dotted line linking the two values. Thus, the attention head identifiers above the stop position are assigned the activation status of “active,” up to and including the stop position. Further, the attention head identifiers below the stop position are assigned the activation status of “inactive.”

In Block 510, a sample response of the transformer model with heads (A2, A4, A3, A5, A1) activated in the encoder self-attention layer is shown. Although three of the eight attention heads are deactivated, overall performance remains unchanged. The retained heads (A2, A4, A3, A5, A1) cover the most crucial functions, such as capturing chemical details, domain-specific vocabulary, long-range dependencies, and basic syntax. The pruned heads (A6, A7, A8) contributed minimal or redundant information. Consequently, deactivating attention heads (A6, A7, A8) reduces computational load without degrading the quality or accuracy of the response.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 6A, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many different types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (602), is configured to perform one or more embodiments, which may include transmitting, receiving, presenting, and displaying data and messages described in the other figures of the disclosure.

The computing system (600) in FIG. 6A may be connected to, or be a part of, a network. For example, as shown in FIG. 6B, the network (620) may include multiple nodes (e.g., node X (622) and node Y (624), as well as extant intervening nodes between node X (622) and node Y (624)). Each node may correspond to a computing system, such as the computing system shown in FIG. 6A, or a group of nodes combined may correspond to the computing system shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6A. Further, the client device (626) may include or perform all or a portion of one or more embodiments.

The computing system of FIG. 6A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a prompt from a user application;
obtaining an attention head ranking, comprising a ranked list of attention head identifiers and corresponding attention head weights, of a transformer model from a configuration classifier processing the prompt;
configuring the transformer model according to the attention head ranking by activating active attention heads and deactivating inactive attention heads of the transformer model, to obtain a configured transformer model; and
processing the prompt by the configured transformer model to obtain a response.

2. The method of claim 1, further comprising:
obtaining a response relevancy score of the response from the user application; and
responsive to the response relevancy score being less than an expected response relevancy threshold corresponding to the prompt,
retraining the configuration classifier to generate a revised attention head ranking corresponding to the prompt.

3. The method of claim 1, further comprising:
selecting a first set of encoder attention heads of an encoder of the transformer model corresponding to the attention head identifiers assigned with an active activation status;
activating the first set of encoder attention heads;
selecting a second set of encoder attention heads of the encoder of the transformer model, corresponding to the attention head identifiers assigned with an inactive attention status; and
deactivating the second set of encoder attention heads.

4. The method of claim 2, wherein obtaining the attention head ranking further comprises:
obtaining a prompt embedding of the prompt;
processing the prompt embedding by the configuration classifier to obtain a candidate attention head ranking comprising a ranked list of candidate attention head identifiers and corresponding candidate attention head weights, and a candidate stop position of the ranked list;
obtaining the expected response relevancy threshold corresponding to the prompt; and
identifying an expected stop position in the candidate attention head ranking wherein a cumulative relevance of the corresponding candidate attention head weights satisfies the expected response relevancy threshold.

5. The method of claim 4, further comprising:
responsive to a non-availability of the expected response relevancy threshold, assigning the candidate stop position as the expected stop position;
assigning the attention head identifiers in the candidate attention head ranking above the expected stop position with an activation status of active; and
assigning the attention head identifiers in the candidate attention head ranking below the expected stop position with the activation status of inactive.

6. The method of claim 1, further comprising:
generating a training dataset for the configuration classifier, by:
selecting a plurality of training prompts and corresponding training response relevancy thresholds from training data,
processing a training prompt of the plurality of training prompts by the transformer model to obtain a corresponding training response,
obtaining the attention head identifiers and the corresponding attention head weights of attention heads used by the transformer model to generate the corresponding training response,
generating a training attention head ranking corresponding to the training prompt, comprising a ranked list having the attention head identifiers and the corresponding attention head weights,
wherein a position of an attention head identifier in the ranked list is based on a corresponding attention head weight, and
adding the training prompt paired with the training attention head ranking to the training dataset.

7. The method of claim 6, further comprising:
determining a cumulative relevance of the training attention head ranking corresponding to the training prompt, wherein the cumulative relevance of the training attention head ranking is a summation of the corresponding attention head weights of the attention head identifiers for each position in the ranked list;
identifying a position in the ranked list of the training attention head ranking wherein the cumulative relevance satisfies a training response relevancy threshold corresponding to the training prompt, as a stop position of the training attention head ranking; and
adding the stop position to the training attention head ranking.

8. The method of claim 1, further comprising training the configuration classifier to:
receive, as input, a user prompt embedding; and
generate, as output, an output attention head ranking comprising a ranked list of attention head identifiers, corresponding attention head weights, and a stop position, the stop position corresponding to a position in the ranked list wherein a cumulative relevance satisfies a training response relevancy threshold.

9. The method of claim 2, further comprising retraining the configuration classifier by:
selecting the expected response relevancy threshold corresponding to the prompt, wherein the expected response relevancy threshold is greater than the response relevancy score;
configuring the transformer model to activate the inactive attention heads of the transformer model;
reprocessing the prompt by the transformer model to obtain a revised response;
obtaining a revised attention head ranking, comprising a revised ranked list of the attention head identifiers and the corresponding attention head weights of attention heads used by the transformer model to generate the revised response;
identifying a revised stop position of the revised attention head ranking wherein a cumulative relevance of the attention head weights satisfies the expected response relevancy threshold; and
adding the prompt paired with the revised attention head ranking, and the revised stop position to a retraining dataset.

10. The method of claim 9, further comprising:
training the configuration classifier with the retraining dataset to receive as input, the prompt, and to generate, as output, the revised attention head ranking.

11. A system comprising:
at least one computer processor;
a configuration classifier, executing on the at least one computer processor;
a transformer model, executing on the at least one computer processor; and
an attention head configurator, executing on the at least one computer processor, wherein the system is configured for:
receiving a prompt from a user application,
obtaining an attention head ranking, comprising a ranked list of attention head identifiers and corresponding attention head weights, of the transformer model from the configuration classifier processing the prompt,
configuring the transformer model by the attention head configurator according to the attention head ranking by activating active attention heads and deactivating inactive attention heads of the transformer model, to obtain a configured transformer model, and
processing the prompt by the configured transformer model to obtain a response.

12. The system of claim 11, further configured for:
obtaining a response relevancy score of the response from the user application, and
responsive to the response relevancy score being less than an expected response relevancy threshold corresponding to the prompt,
retraining the configuration classifier to generate a revised attention head ranking corresponding to the prompt.

13. The system of claim 11, further configured for:
selecting a first set of encoder attention heads of an encoder of the transformer model corresponding to the attention head identifiers assigned with an active activation status;
activating the first set of encoder attention heads;
selecting a second set of encoder attention heads of the encoder of the transformer model, corresponding to the attention head identifiers assigned with an inactive attention status; and
deactivating the second set of encoder attention heads.

14. The system of claim 12, further configured for:
obtaining a prompt embedding of the prompt;
processing the prompt embedding by the configuration classifier to obtain a candidate attention head ranking comprising a ranked list of candidate attention head identifiers and corresponding candidate attention head weights, and a candidate stop position of the ranked list;
obtaining the expected response relevancy threshold corresponding to the prompt; and
identifying an expected stop position in the candidate attention head ranking wherein a cumulative relevance of the corresponding candidate attention head weights satisfies the expected response relevancy threshold.

15. The system of claim 14, further configured for:
responsive to a non-availability of the expected response relevancy threshold, assigning the candidate stop position as the expected stop position;
assigning the attention head identifiers in the candidate attention head ranking above the expected stop position with an activation status of active; and
assigning the attention head identifiers in the candidate attention head ranking below the expected stop position with the activation status of inactive.

16. The system of claim 11, further configured for:
generating a training dataset for the configuration classifier, by:
selecting a plurality of training prompts and corresponding training response relevancy thresholds from training data,
processing a training prompt of the plurality of training prompts by the transformer model to obtain a corresponding training response,
obtaining the attention head identifiers and the corresponding attention head weights of attention heads used by the transformer model to generate the corresponding training response,
generating a training attention head ranking corresponding to the training prompt, comprising a ranked list having the attention head identifiers and the corresponding attention head weights,
wherein a position of an attention head identifier in the ranked list is based on a corresponding attention head weight, and
adding the training prompt paired with the training attention head ranking corresponding to the training prompt to the training dataset;
determining a cumulative relevance of the training attention head ranking corresponding to the training prompt;
identifying a position in the ranked list of the training attention head ranking wherein the cumulative relevance satisfies a training response relevancy threshold corresponding to the training prompt, as a stop position of the attention head ranking; and
adding the stop position to the training attention head ranking corresponding to the training prompt.

17. The system of claim 11, further configured for training the configuration classifier to:
receive, as input, a user prompt embedding; and
generate, as output, an output attention head ranking comprising a ranked list of attention head identifiers, corresponding attention head weights, and a stop position, the stop position corresponding to a position in the ranked list wherein a cumulative relevance satisfies a training response relevancy threshold.

18. The system of claim 12, further configured for retraining the configuration classifier by:
selecting the expected response relevancy threshold corresponding to the prompt, wherein the expected response relevancy threshold is greater than the response relevancy score;
configuring the transformer model to activate the inactive attention heads of the transformer model;
reprocessing the prompt by the transformer model to obtain a revised response;
obtaining a revised attention head ranking, comprising a revised ranked list of the attention head identifiers and the corresponding attention head weights of attention heads used by the transformer model to generate the revised response;
identifying a revised stop position of the revised attention head ranking wherein a cumulative relevance of the attention head weights satisfies the expected response relevancy threshold; and
adding the prompt paired with the revised attention head ranking, and the revised stop position to a retraining dataset.

19. The system of claim 18, further configured for:
training the configuration classifier with the retraining dataset to receive as input, the prompt, and to generate, as output, the revised attention head ranking.

20. A method comprising:
generating a training dataset for a configuration classifier by:
selecting a plurality of training prompts and corresponding training response relevancy thresholds from training data,
processing a training prompt of the plurality of training prompts by a transformer model to obtain a corresponding training response,
obtaining attention head identifiers and corresponding attention head weights of attention heads used by the transformer model to generate the corresponding training response,
generating an attention head ranking corresponding to the training prompt, comprising a ranked list having the attention head identifiers and the corresponding attention head weights,
wherein a position of an attention head identifier in the ranked list is based on a corresponding attention head weight, and
adding the training prompt paired with the attention head ranking to the training dataset;
training the configuration classifier to take as input a user prompt, and generate an output attention head ranking corresponding to the user prompt;
configuring the transformer model according to the output attention head ranking by activating active attention heads and deactivating inactive attention heads of the transformer model to obtain a configured transformer model; and
processing the user prompt by the configured transformer model to obtain a response.
